(19) United States
(12) Patent Application Publication
(10) Pub. No.: US 2005/0264164 A1
(43) Pub. Date: Dec. 1, 2005

(54) Field-emission display having filter layer

(76) Inventor: Kuei-Wen Cheng, Guanyin Township (TW)

Correspondence Address: Yi-Wen Tseng, 4331 Stevens Battle Lane, Fairfax, VA, 22033, US

(21) Appl. No.: 10/852,475

(22) Filed: May 25, 2004

(51) Int. Cl. H01J 1/62; H01J 63/04

(52) U.S. Cl. 313/495

(57) ABSTRACT

A field mission display has a filter layer, using three primary colors, green, red and blue, filters or screen printing or spray to form three primary colors on the light source output surface of the anode electrode layer thereof. When a voltage is applied from a driving circuit to the gate conductive layer and the cathode electrode layer, an electron beam is generated from the cathode electrode layer. The electron beam impinges the white phosphor powder of the anode electrode to create a white light source. The white light is then processed three primary color filters or structures to create a color image. Such device simplifies the structure of the anode electrode layer and the driving circuit. In addition, the luminescent efficiency of various colors of phosphor powder is no longer a factor affects the luminescent characteristics display.

### BACKGROUND OF THE INVENTION

The present invention relates in general to a field-emission display having a filter layer, and more particularly, to a filter structure formed on an anode electrode layer of a field mission display. The filter struck performs color separation of a white light source generated by the anode electrode layer, such that a color image can be obtained.

According to the luminescent efficiency of various colors of phosphor powders, the conventional display provides a brightness ratio of 2:7:1 for red, green and blue colors while a specific voltage is applied thereto. To satisfy a basic color temperature (9600K), the driving current is varied.

FIG. 1 shows a conventional tripolar carbon-nanotube field-emission display. As shown, the display comprises an anode electrode layer 1a constructed by a substrate 11a, a first conductive layer 12a on the substrate 11a and a plurality of second conductive layers 13a on the first conductive layer 12a. The second conductive layers 13a are formed of red (R), green (G) and blue (B) phosphor powders. Each of the second conductive layers 13a and the first conductive layer 12a thereunder construct an anode unit 14a. The display also comprises a cathode electrode layer 2a, which includes a substrate 21a, an insulation layer 22a formed on the substrate 21a and a gate conductive layer 3a on the insulation layer 22a The gate conductive layer 3a and the insulation layer 22a are perforated with holes for exposing portions of the substrate 21a A first conductive layer (silver glue) 24a and a second conductive layer (carbon nanotube) 25a are formed on the exposed portions of the substrate 21a to serve as cathode electrode units 26a.

In the above display, the distance between the electron emission layer and gate layer of the cathode electrode layer is identical. Therefore, the electric field of the driving circuit is designed under the same standard to generate identical electron beam. Therefore, it is difficult to achieve a one-color standard or one-brightness performance. A complex circuit is required to provide a white light mixed by predetermined proportions of red, green and blue components. Alternatively, the driving voltage provided to each color component has to be adjusted individually to balance different luminescent efficiencies of the three primary color components. Typically, the luminescent efficiency is G:R:B=7:2:1.

The conventional cathode-ray tube (CRT) adjusts the luminescent area of each color phosphor surface or the voltage applied to the three color electron gun according to the luminescent efficiency of various colors.

### BRIEF SUMMARY OF THE INVENTION

The present invention provides a field-emission display having a filter formed on a light source output surface of an anode electrode layer, such that the structure of the anode electrode layer and the fabrication of the driving circuit are simplified. In addition, the luminescent efficiency of various colors of phosphor powder is no longer a factor affecting the luminescent efficiency and quality.

The field-emission display provided by the present invention comprises red, green and blue filters or light output sure formed on the anode electrode layer by screen printing or spray. When the driving surface applies a voltage to the gate conductive layer and the cathode electrode layer, an electron beam is generated from the cathode electrode layer. The electron beam impinges the white phosphor powders of the anode electrode layer to generate a white light source. The white light source is then processed by the red, green and blue filters to obtain a required color image.

### BRIEF DESCRIPTION OF THE DRAWINGS

The above objects and advantages of the present invention will be become more apparent by describing in detail exemplary embodiments thereof with reference to the attached drawings in which:

FIG. 1 depicts a conventional tripolar field emission display;

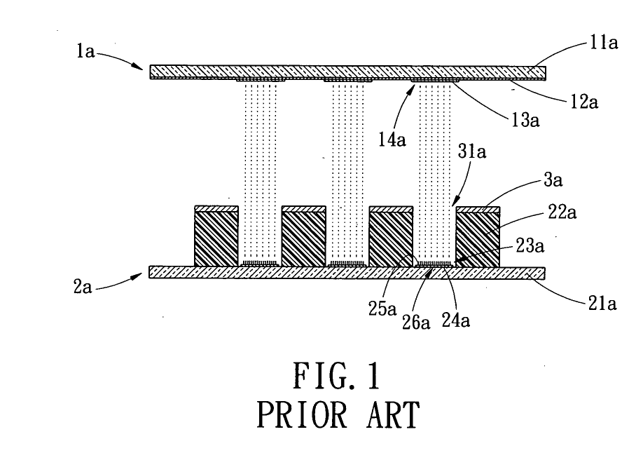

FIG. 2 depicts a tripolar field-emission display according to the present invention;

FIG. 3 illustrates the tripolar field-emission display as shown in FIG. 2 that generates an electron beam; and

FIG. 4 shows a tetra-polar field emission display according to the present invention.

### DETAILED DESCRIPTION OF THE INVENTION

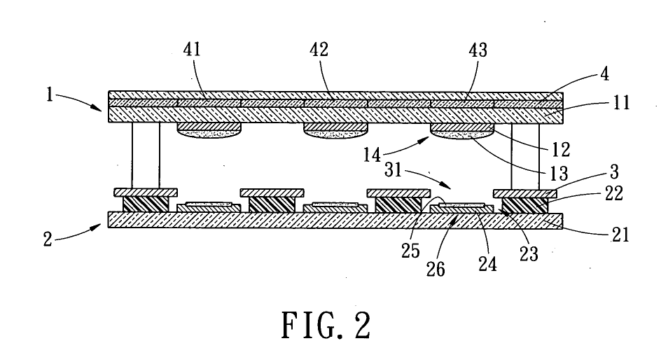

Referring to FIG. 2, a field-emission display having a filter layer comprises an anode electrode layer 1, an anode electrode layer 1, a cathode electrode layer 2, and a filter 4 formed on a light output surface of the anode electrode layer 1. The filter 4 formed on the light output surface of the anode electrode layer 1 performs color separation and mixing on a white light generated by the anode electrode layer 1. Thereby, the structure of the anode electrode layer 1 and the design of the driving circuit are simplified, and the luminescent efficiency of each color is no longer a factor affecting the overall luminescent efficiency and characteristics.

The anode electrode layer 1 includes a substrate 11. Preferably, the substrate 11 is fabricated from glass. A first conductive layer 12 such as an indium-tin oxide (ITO) is formed on the substrate 11. A plurality of second conductive layers 13 is formed on the first conductive layer 12. Preferably, the second conductive layers 13 are fabricated from white phosphor powders. Each of the second conductive layers 13 and the first conductive layer 12 under the second conductive layer 13 constructs an anode electrode unit 14.

The cathode electrode layer 2 includes a substrate 21, an insulation layer 22 formed on the substrate 21, and a gate conductive layer 3 on the insulation layer 22. The substrate 21 includes a glass substrate, and the insulation layer 22 includes a dielectric layer, for example. The gate conductive layer 3 and the insulation layer 22 are perforated with a plurality of holes 23 which expose portions 23 of the substrate 21. On each portion of the exposed substrate 23, a first conductive layer 24 such as silver glue and a second conductive layer such as carbon nanotube 25 are sequentially formed. The first and second conductive layers 24 and 25 construct a plurality of cathode units 26.

The filter 4 includes a plurality of red (R) filters 41, green (G) filters 42, and blue (B) filters 43 formed on the second conductive layers 13 of the anode electrode units 14. The filter 4 includes the transmission type or reflective type filter used in liquid crystal display. The filter 4 is attached to the light output surface, that is, the second conductive layers 13 or formed by screen printing or spray.

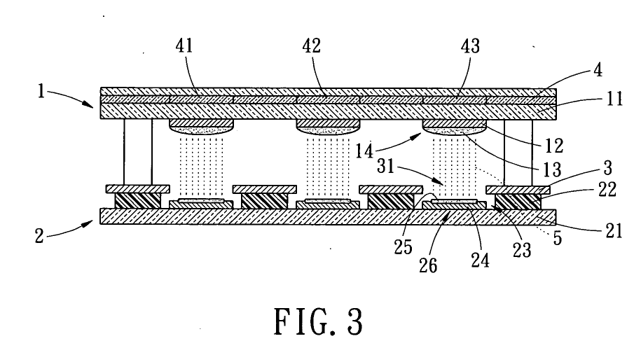

Referring to FIG. 3, when a voltage is applied form a driving circuit to the gate conductive layer 4 and the cathode electrode units 26, an electron beam 5 is generated from the cathode electrode units 26 to propagate towards the anode electrode units 14. When the second conductive layers 14 are impinged by the electron beam, white light is generated by the white phosphor powder to display an image gray scale status. The white light is then processed by the red filters 41, green filters 42 and blue filters 43 to provide a desired color image.

Therefore, the luminescent efficiency of various colors of phosphor powders is not a factor which affects the luminescence of the second conductive layers 13 of the anode electrode units 14. The anode electrode layer 1 is easily fabricated, and the driving circuit can be easily designed

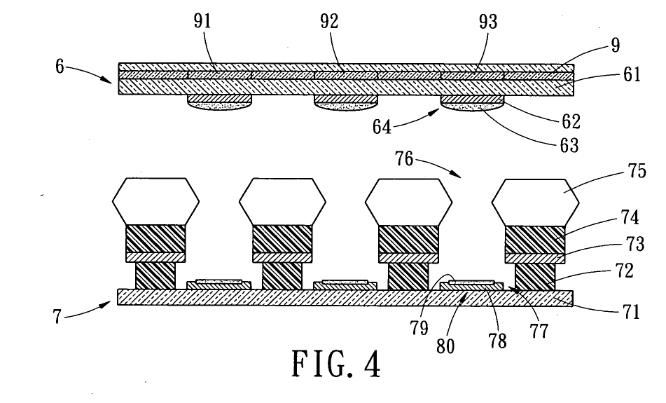

Referring to FIG. 4, a tetra-polar field emission display is provided. The display comprises an anode electrode layer 6 formed of a substrate 61, a first conductive layer 62 formed on the substrate 61, a plurality of second conductive layers 63 formed on the first conductive layer 62. The first conductive layer 62 and the second conductive layers 63 together form a plurality of anode electrode units 64.

The cathode electrode layer 7 includes a substrate 71, a first insulation layer 72 formed on the substrate 71, a gate conductive layer 73 formed on the first insulation layer 72, and a second insulation layer 74 formed on the gate conductive layer 73, and a converging layer 74 formed on the second insulation layer 73. The converging layer 74, the second insulation layer 74, the gate conductive layer 72 and the first insulation layer 71 are patterned to form a plurality of holes 76 exposing portions 77 of the substrate 7. The exposed portions of substrate 77 are then covered with first conductive layers 78 and second conductive layers 79. The first and second conductive layers 78 and 79 together serve as the cathode electrode units 80.

The filter structure 9 includes red filters 91, green filters 92 and blue filters 93 covering the anode electrode units 64. The filter structure 9 includes transmission-type or reflective-type filters used in liquid crystal display. The filter structure 9 can also be applied by screen printing or spray directly on the second conductive layers 63 of the anode electrode units 64.

When the driving circuit applies a voltage across the gate conductive layer 73 and the cathode electrode units 80, an electron beam is generated from the cathode electrode units 80 towards the anode electrode units 64. Being impinged by the electron beam, the white phosphor powder on the anode electrode units 64 generates a white light in an image gray scale state. The filter structure 9 then performs color separation and/or mixing to generate a desired color image.

The filter structure 4 and 9 can also adapt the color coordinate (0.251, 0.291) for ZnS:Ag+(Zn,Cd)S:Cu,Al or (0.253, 0.311) for Y₂O₂S:Tb phosphor powders under 2 KV used in the conventional black-and-white cathode ray tube. Alternatively, the three color P-22 (with major component of ZnS) phosphor powders can be used.

While the present invention has been particularly shown and described with reference to preferred embodiments thereof, it will be understood by those of ordinary skill in the art the various changes in form and details may be made therein without departing from the spirit and scope of the present invention as defined by the appended claims.

1. A filed mission display, comprising:
an anode electrode layer, having a plurality of anode electrode units;
a cathode electrode layer, having a patterned gate conductive layer formed on a substrate and a plurality of cathode electrode units formed on the substrate between the patterned gate conductive layer; and
a filter structure on the anode electrode units, wherein the filter structure includes at least a set of red filter, green filter and blue filter.

2. The display of claim 1, wherein the anode electrode units are formed on a glass substrate.

3. The display of claim 1, wherein the anode electrode units comprise a first conductive layer and a plurality of second conductive layers formed on the first conductive layer.

4. The display of claim 3, wherein the second conductive layers include white phosphor powder.

5. The display of claim 3, wherein the first conductive layer includes an indium-tin oxide layer.

6. The display of claim 1, wherein the cathode electrode units comprise a plurality of first conductive layers and a plurality of second conductive layers.

7. The display of claim 6, wherein the first conductive layers include a plurality of layers of silver glue.

8. The display of claim 6, wherein the second conductive layers include a plurality of carbon nanotube.

9. The display of claim 1, wherein the filter shuck includes a plurality of red filters, green filters and blue filters.

10. The display of claim 1, wherein the filter structure includes a transmission type or reflective type filter.

11. The display of claim 1, wherein the filter structure includes a plurality of red, green and blue filtering elements formed on the anode electrode units by screen printing.

12. The display of claim 1, wherein the filter structure includes a plurality of red, green and blue filtering elements sprayed on the anode electrode units.

13. The display of claim 1, wherein the filter structure includes color coordinate (0.251, 0.291) for phosphor powder ZnS:Ag+(Zn,Cd)S:Cu,Al used for a black-and-white cathode ray tube under 2 KV.

14. The display of claim 1, wherein the filter structure includes color coordinate (0.253, 0.311) for phosphor powder Y₂O₂S:Tb used for a black-and-white cathode ray tube under 2 KV.

15. The display of claim 1, wherein the filter structure includes mixed P-22 red, green and blue phosphor powders.

16. A field emission display, comprising:
an anode electrode layer, having a plurality of anode electrode units;
a cathode electrode layer, having a plurality of stacks of gate conductive layers, insulation layers, converging layers formed on a substrate;
a plurality of cathode electrode units formed on the substrate between the stacks; and
a filter structure on the anode electrode units.

17. The display of claim 16, wherein the filter structure includes a plurality of red, green and blue filtering elements attached to the anode electrode units.

18. The display of claim 16, wherein each of the stacks further comprises an additional insulation between the substrate and the gate conductive layer.

19. The display of claim 16, wherein the surface level of the cathode electrode units is lower than the sure of the stacks.
